(19) United States
(12) Patent Application Publication
(10) Pub. No.: US 2008/0151076 A1
(43) Pub. Date: Jun. 26, 2008

(54) PHOTOGRAPHING APPARATUS, METHOD AND PROGRAM

(75) Inventor: Yasuo TAKANE, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/962,759

(22) Filed: Dec. 21, 2007

(30) Foreign Application Priority Data
Dec. 26, 2006 (JP) 2006350372

(51) Int. Cl. H04N 5/76

(52) U.S. Cl. 348/231.99

(57) ABSTRACT

A photographing apparatus which converts a subject image received via a photographic optical system into image data, compresses and encodes the image data, and stores the image data in a predetermined storage medium, comprises a calculation part which calculates the storable number of image data according to an available space of the predetermined storage medium using a predetermined prediction function, a shooting condition setting part which sets a shooting condition, a target code amount setting part which sets a target code amount of image data according to the set shooting condition, a compression rate setting part which sets a compression rate of image data to reach the set target code amount, and a prediction function correcting part which corrects the prediction function to be used by the calculation part, based on the set compression rate. Thereby, it enables to reliably predict the number of remaining shots.

### BACKGROUND OF THE INVENTION

1. Field of the Invention

The present invention relates to a photographing apparatus which records image data by compressing and coding the image data.

2. Description of the Related Art

A file capacity after compressing and coding the image depends on a shooting scene. Therefore, the number of images which can be stored in a fixed capacity of the medium depends on how the user takes the photographs. Conventionally, since the medium has a small capacity, a fixed length process (in which the file capacity is estimated beforehand by pre-compression and the main compression ensures that the code amount is almost constant) is performed to assure the minimum number of shots, and the file capacity is made almost constant by changing the compression rate in any scene, thereby securing the minimum number of shots and displaying the number of remaining shots (the storable number of shots).

With this method, though the calculation of the number of remaining shots is accurate, the signal processing takes time because the pre-compression is performed, and the compression rate becomes high when a complex and highly precise subject is photographed. Conversely, in a monotonous subject (such as a uniform wall) which causes no problem even when the compression rate is high, the file capacity is often redundant. Japanese Patent Application Laid-Open No. 2-105686, Japanese Patent Application Laid-Open No. 2000-175146, Japanese Patent Application Laid-Open No. 2004-134940 and Japanese Patent Application Laid-Open No. 2001-94849 are examples of such related art.

### SUMMARY OF THE INVENTION

When the compression rate is changed to keep the file capacity almost constant, it is difficult to predict the number of remaining shots. When the fixed length process is not performed, it is more difficult to predict the number of remaining shots. It is an object of the invention to reliably predict the correct number of remaining shots even in a situation where the compression rate is changed according to the shooting condition.

According to an aspect of the invention, there is provided a photographing apparatus which converts a subject image received via a photographic optical system into image data, compresses and encodes the image data, and stores the image data in a predetermined storage medium, comprising a calculation part which calculates the storable number of image data according to an available space of the predetermined storage medium using a predetermined prediction function, a shooting condition setting part which sets a shooting condition including changing a shooting mode or adding a shooting function, a target code amount setting part which sets a target code amount of image data according to the shooting condition set by the shooting condition setting part, a compression rate setting part which sets a compression rate of image data to reach the target code amount set by the target code amount setting part, and a prediction function correcting part which corrects the prediction function to be used by the calculation part, based on the compression rate set by the compression rate setting part.

With the aspect of this invention, when the compression rate is set based on the target code amount set according to the shooting condition, the prediction function for predicting the number of remaining shots is corrected based on this compression rate. Accordingly, even when the target code amount or the compression rate is varied depending on the shooting condition, the number of remaining shots can be correctly predicted.

According to an aspect of the invention, this photographing apparatus may further comprise a digital zoom part which carries out a digital zoom for the image data, wherein when the shooting condition setting part sets the digital zoom of the digital zoom part to turn on, the target code amount setting part can set the target code amount to a lower value than a predetermined code amount threshold.

According to an aspect of the invention, this photographing apparatus may further comprise an image stabilizing part which corrects a camera shake of the photographing apparatus, wherein when the shooting condition setting part sets the image stabilization of the image stabilizing part to turn on, the target code amount setting part can set the target code amount to a lower value than a predetermined code amount threshold.

According to an aspect of the invention, the image stabilizing part may perform digital image stabilization.

According to an aspect of the invention, the prediction function may comprise a table which defines the compression rate for each shooting condition according to the available space.

The target code amount setting part preferably increases or decreases the target code amount above or below the predetermined code amount threshold in response to a shutter speed and an aperture value being set within a specific area in a program diagram which defines the relationship between the shutter speed and the aperture value in the photographic optical system.

That is, the compression rate can be optimized in consideration of a difference in the exposure condition.

The target code amount setting part preferably increases or decreases the target code amount above or below the predetermined code amount threshold in response to a shutter speed and a photographic sensitivity being set within a specific area in a program diagram which defines the relationship between the shutter speed and the photographic sensitivity in the photographic optical system.

That is, the compression rate can be optimized in consideration of a difference in the photographic sensitivity.

According to an aspect of the invention, there is provided a photographing method which converts a subject image received via a photographic optical system into image data, compresses and encodes the image data, and stores the image data in a predetermined storage medium, comprising a step of calculating the storable number of image data according to an available space of the predetermined storage medium using a predetermined prediction function, a step of setting a shooting condition including changing a shooting mode or adding a shooting function, a step of setting a target code amount of image data according to the set shooting condition, a step of setting a compression rate of image data to reach the set target code amount, and a step of correcting the prediction function, based on the set compression rate.

The invention also includes a program for causing a computer to perform the above photographing method.

According to an aspect of the invention, there is provided a photographing apparatus which converts a subject image received via a photographic optical system into image data, compresses and encodes the image data, and stores the image data in a predetermined storage medium, comprising a calculation part which calculates the storable number of image data according to an available space of the predetermined storage medium using a predetermined prediction function, a shooting condition setting part which sets a shooting condition including changing a shooting mode or adding a shooting function, a storage part which stores a table which defines a compression rate for each shooting condition corresponding to the available space of the predetermined storage medium, a compression rate setting part which sets the compression rate corresponding to the shooting condition set by the shooting condition setting part and the current available space of the predetermined storage medium by referring to the table of the storage part, and a prediction function correcting part which corrects the prediction function to be used by the calculation part, based on the compression rate set by the compression rate setting part.

With the aspect of this invention, the compression rate corresponding to the current available space of the storage medium and the set shooting condition is specified from the table, and the function is corrected according to this compression rate. Accordingly, the accurate number of remaining shots can be calculated by the function corrected at the compression rate specified from the table, even when setting of the target code amount or the pre-compression is omitted.

However, it is required that the compression rate defined in the table is set to statistically valid value to reach approximately the default target code amount for each shooting condition whatever image data is compressed.

According to an aspect of the invention, there is provided a photographing method which converts a subject image received via a photographic optical system into image data, compresses and encodes the image data, and stores the image data in a predetermined storage medium, comprising a step of calculating the storable number of image data according to an available space of the predetermined storage medium using a predetermined prediction function, a step of setting a shooting condition including changing a shooting mode or adding a shooting function, a step of storing a table which defines a compression rate for each shooting condition corresponding to the available space of the predetermined storage medium, a step of setting the compression rate corresponding to the set shooting condition and the current available space of the predetermined storage medium by referring to the table, and a step of correcting the prediction function, based on the set compression rate.

According to an aspect of the invention, there is provided a program for causing a computer to perform the above photographing method.

With the aspect of this invention, when the compression rate is set based on the target code amount set according to the shooting condition, the prediction function for predicting the number of remaining shots is corrected according to this compression rate. Accordingly, even when the target code amount or the compression rate is varied depending on the shooting condition, the number of remaining shots can be accurately predicted.

Also, with the aspect of this invention, the compression rate corresponding to the current available space of the storage medium and the set shooting condition is specified from the table, and the function is corrected according to this compression rate. Accordingly, the number of remaining shots can be accurately calculated by the function corrected at the compression rate specified from the table, even when setting of the target code amount or the pre-compression is omitted.

### BRIEF DESCRIPTION OF THE DRAWINGS

FIG. 1 is a schematic block diagram of a camera;

FIG. 2 is a flowchart showing the flow of a remaining shot number calculation process according to a first embodiment;

FIG. 3 is a flowchart showing the flow of a remaining shot number calculation process according to a second embodiment;

FIG. 4 is a flowchart showing the flow of a remaining shot number calculation process according to a third embodiment;

FIG. 5 is a flowchart showing the flow of a remaining shot number calculation process according to a fourth embodiment;

FIG. 6 is a flowchart showing the flow of a remaining shot number calculation process according to a fifth embodiment;

FIGS. 7A to 7C are views exemplifying a function which defines the compression rate according to the number of taken shots;

FIG. 8 is a view exemplifying a number of remaining shots decision function;

FIG. 9 is a view exemplifying a table which defines the compression rate according to the shooting mode and the number of remaining shots;

FIG. 10 is a view exemplifying a program diagram which defines the relationship between the shutter speed and the aperture value for each shooting mode; and

FIG. 11 is a view exemplifying a program diagram which defines the relationship between the shutter speed and the ISO speed for each shooting mode.

### DETAILED DESCRIPTION OF THE PREFERRED EMBODIMENTS

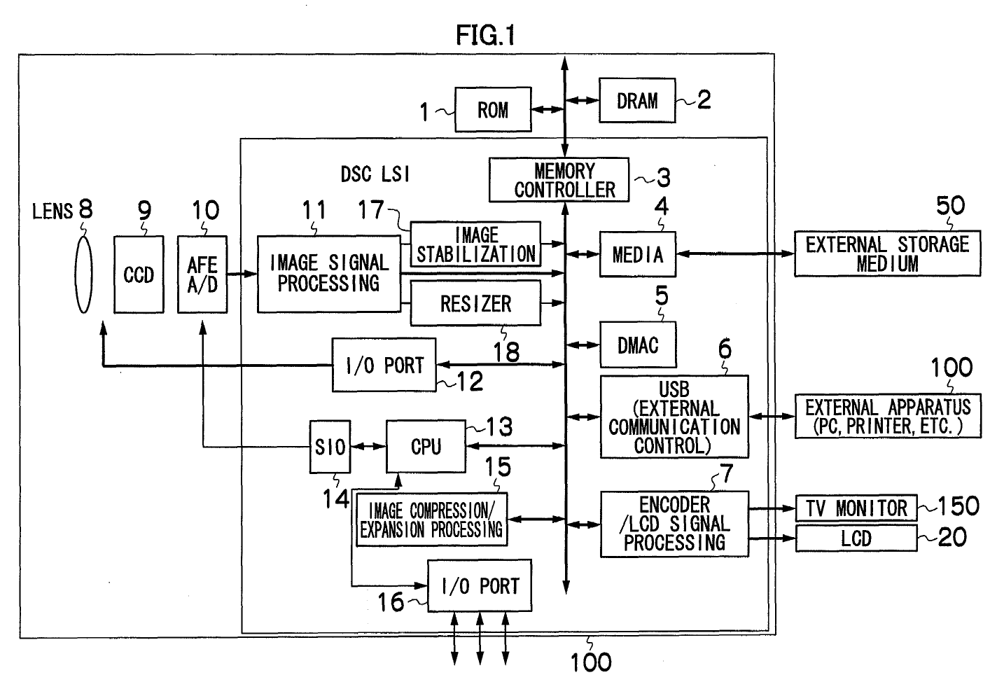

FIG. 1 is a schematic block diagram of a camera 100 according to a preferred embodiment of the present invention. A lens 8 disposed on the front face of a camera unit internally comprises an image taking lens including a zoom lens and a focus lens. When the zoom lens is moved in the optical axis direction, the focal distance is adjusted. When the focus lens is moved in the optical axis direction, the focusing is adjusted. An instruction of focal length adjustment and focusing adjustment is sent via a serial input/output terminal (SIO) 14 from a CPU 13.

A number of photo-sensors are arranged two-dimensionally on a light receptive surface of a CCD 9. A subject light incident upon the light receptive surface is converted into a signal charge in the amount according to the incident light amount by each photo-sensor. And the signal charge accumulated in each photo-sensor is read in accordance with a timing pulse given from a timing generator (TG), not shown, and outputted as a voltage signal (image signal) according to the signal charge via a vertical transfer path and a horizontal transfer path.

Also, the camera 100 comprises an AFE 10 which carries out a CDS processing/gain processing for an analog signal from the CCD 9 and carries out the A/D conversion for digital RGB image data, and a memory controller 3 which carries out the control for storing a YC image signal sent from an image signal processing part 11 by converting an RGB image signal from the AFE 10 into the YC image signal, or CCD-RAW data not subjected to an RGB interpolation process, in a DRAM 2, or reading the CCD-RAW data or the YC image signal in the DRAM 2 and outputting it.

The camera 100 comprises an encoder/LCD signal processing circuit 7. The encoder/LCD signal processing circuit 7 converts the YC image signal inputted into the DRAM 2 into an NTSC (National TV Standards Committee) signal, and supplies it to an external TV monitor 150 to display a video based on the image signal. Also, it supplies the YC image signal to an LCD 20 contained in the camera 100 to display the video based on the image signal.

The CPU 13 generally controls the overall camera 100. A ROM 1 stores a program, etc. which is executed by the CPU 13.

A DMAC (Direct Memory Access Controller) 5 performs an operation of directly writing various kinds of data such as image data, etc. inputted from the image signal processing part 11 into the DRAM 2.

The image signal processing part 11 performs various kinds of processing for the CCD-RAW image data inputted from the AFE 10.

An image compression/expansion processing part 15 converts the image data into an image file compressed and encoded in a predetermined format such as JPEG to record the image file via a media controller 4 on an external storage medium 50.

A USB communication part 6 is connected to an external apparatus 100 such as a personal computer or a printer, etc., and sends or receives various kinds of data.

An image stabilizing part 17 detects the movement vector information such as a movement of the camera 100 itself from a jitter of the video signal, etc. supplied from the image signal processing part 11, for example, and corrects the camera shake by instructing an image pickup device driving circuit, not shown, to shift the start position of a drive pulse for the CCD 9 by a vector amount of obtained vector information in the reverse direction. This is called digital image stabilization.

A resizer 18 performs a digital zoom in accordance with an operation of a zoom key. The digital zoom means electrically enlarging an image by cutting out a part of the image, and performing an interpolation process for the pixel value insufficient to enlarge the cut out part to the normal angle of view with neighboring pixel values.

Though the resizer 18 is requisite for the camera of a second embodiment 100 and the image stabilizing part 17 is requisite for the camera 100 of a fourth embodiment, they are not required in other embodiments.

### First Embodiment

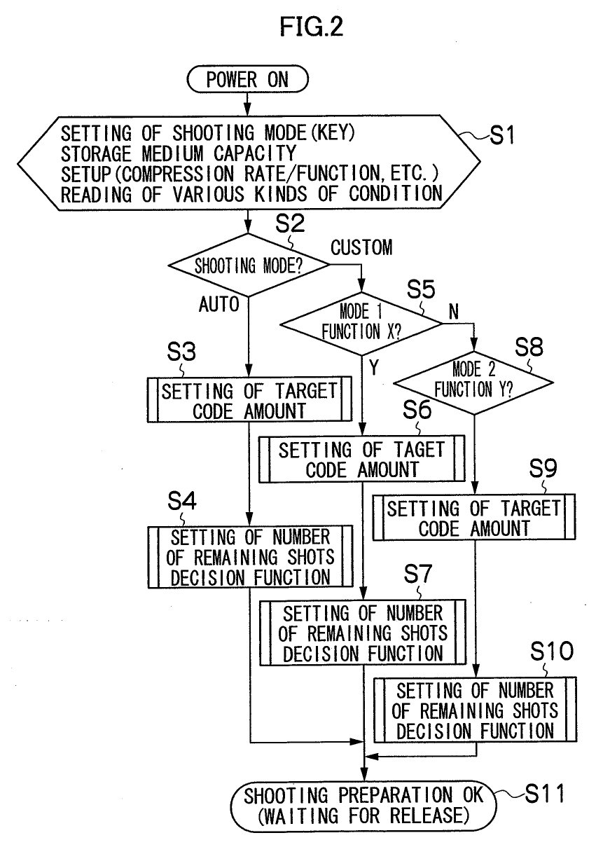

Referring to a flowchart of FIG. 2, the flow of a remaining shot number calculation process according to a preferred first embodiment of the invention will be described below.

At S1, the CPU 13 sets a shooting mode in accordance with a key operation, or accepts the setting of an optional shooting function, reads the number of taken shots (the number of shots which have been taken) stored in the external storage medium 50, and reads various kinds of shooting condition regarding the image recording according to the set shooting mode, etc. from the ROM 1.

The remaining capacity of the external storage medium 50 is obtained by subtracting the average data amount per image multiplied by the number of taken shots from the maximum storage capacity of the external storage medium 50. Accordingly, the remaining capacity of the external storage medium 50 and the number of taken shots are equivalent in the concept.

At S2, the set and accepted shooting mode is determined. Also, at S5 and S8, it is determined whether or not the function X and Y, respectively, is additionally set to a Custom mode.

Herein, for the sake of convenience, an “Auto” mode or “Custom” mode can be set as the shooting mode, and a “mode 1 function X” and a “mode 2 function Y” can be set as the additional function. The “Custom” corresponds to the conventional sports mode or character mode. However, as a matter of course, other shooting modes or additional functions may be settable.

The operation goes to S3 when the Auto mode is set, to S5 when the Custom mode is set, to S6 when the “mode 1 function X” is further set in the Custom mode, or to S9 when the “mode 2 function Y” is further set in the Custom mode.

At S3, S6 and S9, the target code amount (value marking the code amount of image after compression) of image is set in accordance with the set mode and additional function, and the read number of taken shots x. This process is similar to the conventional process for deciding the target compression rate (target code amount) of image data according to the setting of image quality for compression (e.g., switching of FINE/NORMAL/BASIC).

At S4, S7 and S10, the approximate code amount is calculated by performing a compression process (pre-compression) for one frame of image among the live-view images supplied continually from the image signal processing part 11. And a function f(x) is set up of deciding the compression rate at which the amount of image data after compression is nearly equal to the set target code amount according to the number of taken shots x, based on the calculated code amount.

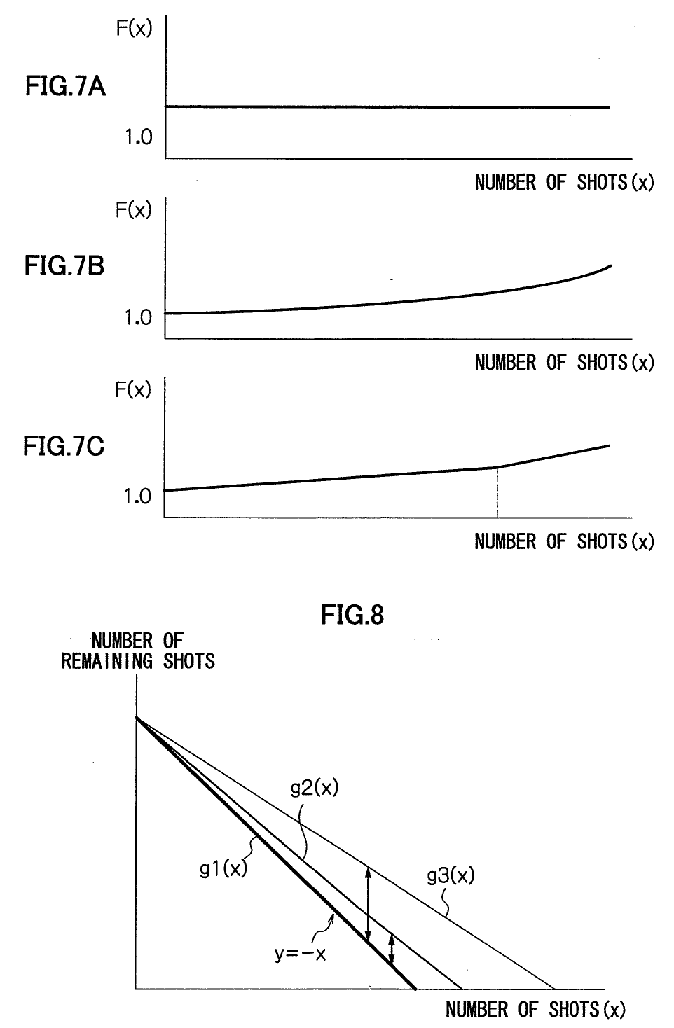

Specifically, a function f(x) which defines the compression rate according to the number of taken shots x is set up, as shown in FIG. 7A, 7B or 7C.

According to the function of FIG. 7A, images are compressed at a constant compression rate, irrespective of the number of taken shots, but according to the function of FIG. 7B or 7C, the inclination of f(x) increases as the number of taken shots x increases. Thereby, the storage capacity is prevented from being tight to cause the image to be unrecorded as practicable as possible, as the number of taken shots increases.

The secondary differential coefficient is always positive as the function of FIG. 7B, or the first differential coefficient (inclination) increases when x is greater than or equal to a predetermined number x0 as the function of FIG. 7C. In the function of FIG. 7B, since the compression rate is remarkably raised near the full capacity, the photographing can be continued even in a severe situation where the available space is small, whereby the remaining capacity can be effectively used up to the end. Instead of the non-linear function as shown in FIG. 7B, a linear function in which the non-linear function is Newton approximated may be employed, in which the first differential coefficient (inclination) may be rapidly raised near the full capacity to greatly increase the compression rate near this full capacity.

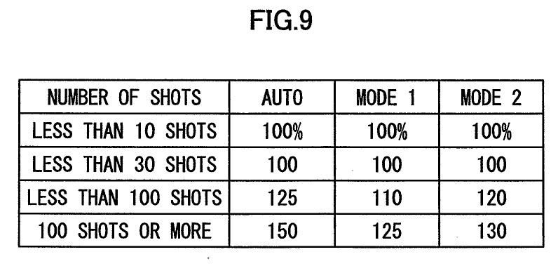

When the compression rate is decided by these functions, the compression rate can be increased according to the decreasing remaining capacity of the external storage medium 50, or when the remaining capacity is less than a fixed value. Thus, the unrecorded image is prevented from occurring as practicable as possible, when the storage capacity for the image is smaller. The compression rate decision function f(x) may be linear as shown in FIG. 7A or 7C, or non-linear as shown in FIG. 7B. Or it may be a step function as shown in a table (see FIG. 9), as will be described later.

And the compression rate f(x1) is decided by substituting the number of taken shots x=x1 read at S1 into the set function f(x).

Further, a function g(x) for deciding the maximum storable number of images (the number of remaining shots) is changed according to the number of taken shots x, based on the compression rate decision function f(x).

As a specific example, the inclination of a default number of remaining shots decision function g1(x) is shifted counter-clockwise by a rotation angle according to the compression rate f(x) to produce a number of remaining shots decision function g2(x) with the changed inclination, as shown in FIG. 8. Since the number of remaining shots is increased as the compression rate is raised, the number of remaining shots decision function is changed to obtain the number correctly.

That is, assuming that the image is compressed at the constant target code amount at any time, irrespective of the target code amount according to the shooting mode, the number of remaining shots decision function g1(x) can be set as follows.

g1(x)=(remaining capacity of storage medium)/(target code amount)

It is assumed that the target code amount of g1(x) is constant. In practice, however, when the number of taken shots x is increased, the compression rate is increased by f(x), whereby the target code amount is changed in a decreasing direction according to the number of taken shots x. Therefore, there may be inconvenience that the number of remaining shots calculated using g1(x) is estimated inaccurately to be smaller than the actual number of remaining shots.

Thus, as the set compression rate is proportional to the number of remaining shots,

g2(x)=g1(x)×f(x)={(remaining capacity of storage medium)/(target code amount)}×f(x)

whereby the default number of remaining shots decision function g1(x) is corrected with the compression rate decision function f(x) to obtain g2(x). When the number of taken shots x=x1 is substituted into g2(x), the accurate number of remaining shots according to the target code amount for each mode is calculated. The calculated number of remaining shots g2(x1) is notified to the user by displaying it on the LCD 20, etc. or notified to the user.

Assuming that all the images are compressed at the maximum code amount, the number of remaining shots decision function g3(x)

g3(x)=(remaining amount of capacity of storage medium)/(maximum code amount)

In g3(x), there is no consideration of the compression rate increase due to f(x) and it is assumed that any image is recorded uniformly at the maximum code amount, the number of remaining shots calculated using g3(x) is estimated to be larger than the actual number of remaining shots. Therefore, there is high possibility that the external storage medium 50 becomes full before the predicted number of remaining shots is reached.

When the number of taken shots x=x1 is substituted into the function g2(x) changed according to the variation of compression rate, the number of remaining shots g2(x1) is calculated.

At S11, the live-view image is displayed on the LCD 20, and the operation waits for depression of a release switch.

In this embodiment, the appropriate target code amount according to the shooting mode is set, and the image can be compressed and recorded with the appropriate code amount according to the scene. In addition, since the number of remaining shots decision function is corrected according to the set compression rate, the number of remaining shots is correctly calculated. Hence, it is possible to prevent the external storage medium 50 from being full before the displayed number of remaining shots is reached, or prevent the image from being still stored in the external storage medium 50 even though the displayed number of remaining shots is reached, whereby it is possible to prevent the notification of the inaccurate number of remaining shots.

### Second Embodiment

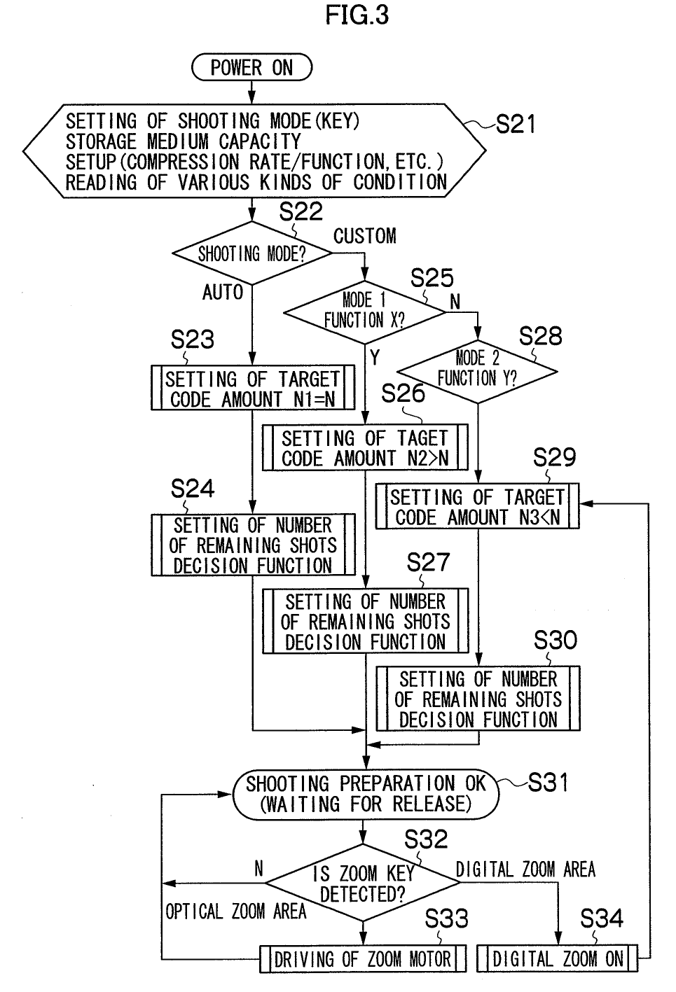

Referring to a flowchart of FIG. 3, the flow of a remaining shot number calculation process according to a second preferred embodiment of the invention will be described below.

S21 to S31 are the same as S1 to S11 in the first embodiment. However, assuming that the target code amounts set at S23, S26 and S29 are N1, N2 and N3, and the normal target code amount is N, the relationship N3<N1=N<N2 is satisfied.

At S32, a manipulation of a zoom key, not shown, is detected. The operation goes to S33 when the magnification instructed by the manipulation of the zoom key is within a corresponding range of the optical zoom, or to S34 when it is outside the corresponding range of optical zoom, viz., within a corresponding range of the digital zoom.

At S33, the lens 8 is moved to the telephoto side or wide-angle side in accordance with the manipulation of the zoom key.

At S34, the resizer 18 carries out a digital zoom for the image according to the manipulation of the zoom key. And the operation returns to S29 to set the target code amount N3.

The digital zoom means electronically enlarging an image by cutting out a part of the image, and performing an interpolation process for the pixel value insufficient to enlarge the cut out part to the normal angle of view with neighboring pixel values. Accordingly, as the magnification of the digital zoom is larger, the image (image quality) is more greatly degraded through the interpolation process described above. Therefore, even when the code amount of the image subjected to the digital zoom is the smaller value N3 than the normal value N, the image quality is less degraded, and it is appropriate as a measure for ensuring the number of remaining shots.

That is, the number of remaining shots can be more preferentially secured than the image quality of the image subjected to the digital zoom, and the number of remaining shots can be calculated correctly.

### Third Embodiment

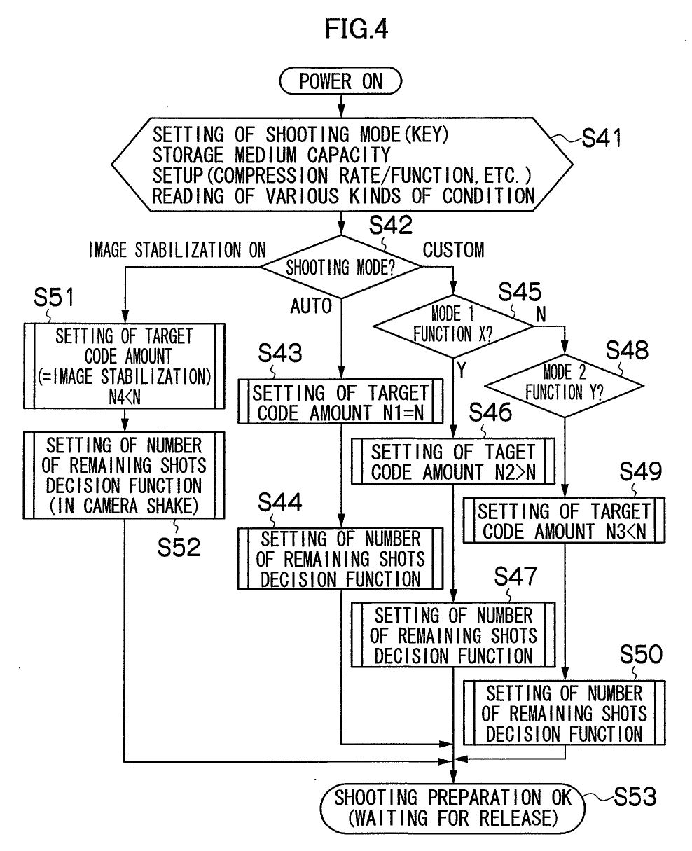

Referring to a flowchart of FIG. 4, the flow of a remaining shot number calculation process according to a preferred third embodiment of the invention will be described below.

S41 to S50 and S53 are the same as S21 to S30 and S31 in the second embodiment, except for the setting of an “image stabilization (camera shake correction) ON” as the shooting mode is discriminated at S42. When the setting of the “image stabilization ON” is discriminated, the operation goes to S51. The setting of the “image stabilization ON” is made when the camera shake is detected.

At S51, the target code amount N4 of the image according to the image stabilization ON is set. Herein, it is assumed that the relationship N4<N is satisfied. This is because the image where the camera shake occurs is degraded in the image quality, and has less influence on the image quality even when the target code amount is reduced and the compression rate is raised.

When the target code amount N4 is set, the function f(x) of deciding the compression rate at which the image data amount is within the target code amount is set up. As a specific example, the function f(x) which defines the increasing compression rate according to the increase of the number of taken shots x, as shown in FIG. 7B or 7C is set.

Next, the compression rate f(x1) is decided by substituting the read number of shots taken x=x1 into the set function f(x) in the same manner as at S30. Also, the number of remaining shots decision function g(x) is changed according to the function f(x).

In the image stabilization ON, the digital image stabilization is made by the image stabilizing part 17. However, instead of the digital image stabilization, an optical image stabilization may be made, namely, a prism or lens member capable of displacement on the optical axis may be disposed midway on the optical path of the photographing light incident from the lens 8 on the CCD 9 and the optical axis may be displaced according to the camera shake by using the prism or lens to carry out the image stabilization.

Even when the correction is made by any method, the degradation in the image quality is not negated compared with the image where no camera shake occurs. Accordingly, the number of remaining shots is more preferentially secured than the image quality of the image where the camera shake occurs, whereby the number of remaining shots is calculated correctly.

### Fourth Embodiment

Referring to a flowchart of FIG. 5, the flow of a remaining shot number calculation process according to a preferred fourth embodiment of the invention will be described below.

S61 to S73 are the same as S41 to S53 in the third embodiment.

At S74, it is determined whether or not the release switch is pressed. When pressing the release switch is detected, the operation goes to S75.

At S75, a movement detection circuit provided in the image stabilizing part 17 detects a movement such as a shake of the camera 100 itself from a jitter of a video signal, for example, and sends a vector indicating the movement to the CPU 13 or an image pickup device driving circuit, not shown.

The image stabilizing part 17 judges whether or not the occurring camera shake is within the correctable range, based on the movement vector. The operation goes to S76 when it is judged that the camera shake is within the correctable range, or to S77 when it is judged that the camera shake is outside the correctable range.

At S76, the image stabilizing part 17 instructs the image pickup device driving circuit to shift the start position of a drive pulse for the CCD 9 by the vector amount of obtained vector information in the reverse direction to correct the camera shake. The image after completion of image stabilization is compressed and recorded at the target code amount set at S71, S63, S66 or S69, and the compression rate f(x) set according to this target code amount.

At S77, the target code amount is reset to N4, and the image compression/expansion processing part 15 sets the compression rate f(x1) according to this to compress and record the image. Namely, the image is not compressed at the target code amount N1 to N3 set at S63, S66 or S69, but compressed and recorded at the smaller target code amount N4 (N4<N1, N2, N3) according to the occurrence of camera shake (main compression). Thereafter, the number of remaining shots decision function is changed and the number of remaining shots is calculated in the same manner as at S52.

Thereby, the number of remaining shots can be preferentially secured by recording only the image of bad quality for which the image stabilization is impossible at the higher compression rate. Also, the number of remaining shots can be calculated correctly.

### Fifth Embodiment

The compression rate may be decided, using a table which defines the compression rate according to the shooting mode and the number of remaining shots, instead of the function f(x) of deciding the compression rate.

In this case, the remaining shot number calculation process is as follows.

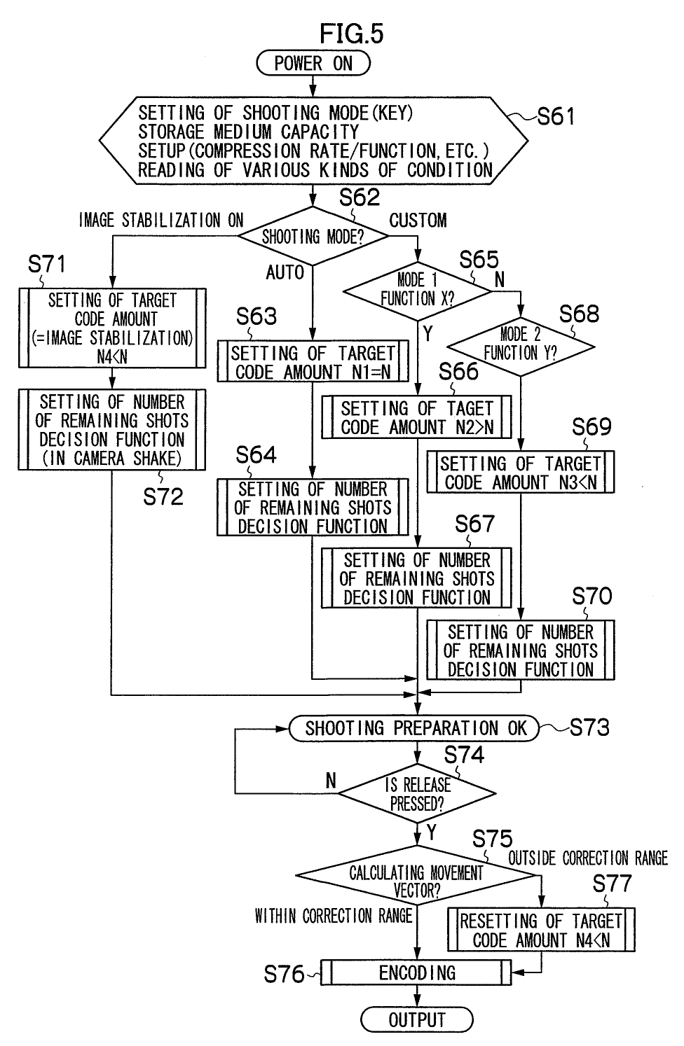

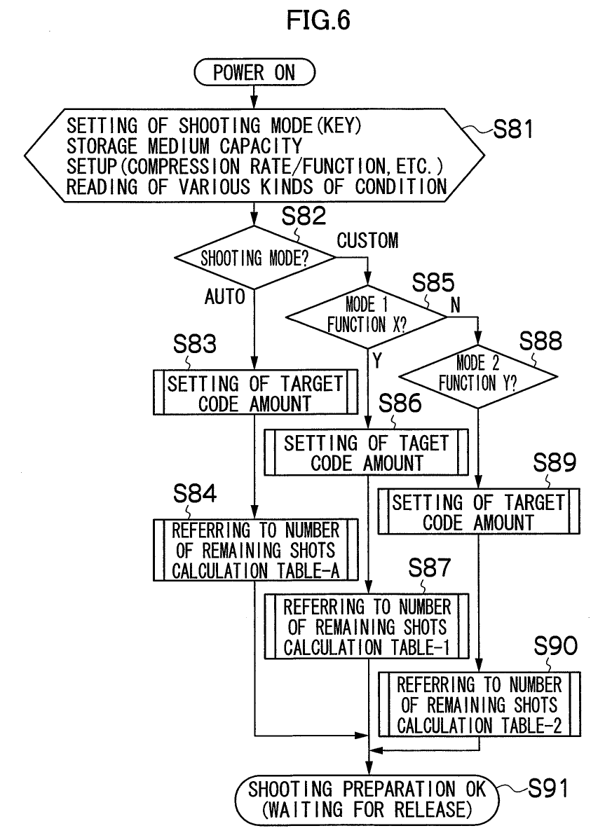

That is, S81 to S91 of the remaining shot number calculation process according to a fifth embodiment as shown in FIG. 6 are the same as S1 to S11 of the remaining shot number calculation process of FIG. 2 (first embodiment), except that at S84, S87 and S90, the compression rate corresponding to the number of taken shots x1 read at S81 and the shooting mode and additional function discriminated at S82, S85 and S88 are specified by referring to a table (FIG. 9) stored beforehand in the ROM 1. The number of remaining shots decision function is corrected according to this compression rate, and the number of remaining shots is calculated by substituting the number of taken shots x1 into the corrected function.

In this manner, the calculation of the number of remaining shots is made faster, and the memory resource is saved.

### Sixth Embodiment

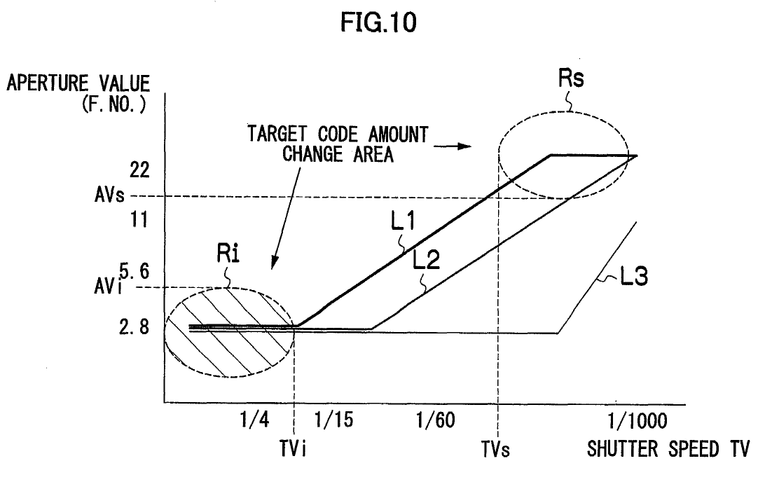

FIG. 10 shows the program diagrams L1 to L3 according to the shooting mode (or optional shooting function). Herein, the shutter speed TV is taken along the transverse axis, and the aperture value AV (also called F. No) of the photographic optical system is taken along the longitudinal axis, whereby the relationship between the shutter speed TV and the aperture value for each shooting mode (or optional shooting function) is stipulated.

For example, L1 is a program diagram corresponding to the AUTO mode, L2 is a program diagram corresponding to the function X of mode 1, and L3 is a program diagram corresponding to the function Y of mode 2.

Herein, the target code amount (N1, N2, N3, N4, etc.) may be decreased and the compression rate may be increased in a predetermined target code amount change area Ri where the shutter speed TV is less than a predetermined lower limit threshold TVi and the aperture value is less than a predetermined lower limit threshold LVi.

Or the target code amount (N1, N2, N3, N4, etc.) may be increased and the compression rate may be decreased in a predetermined target code amount change area Rs where the shutter speed TV is greater than or equal to a predetermined upper limit threshold TVs and the aperture value is greater than or equal to a predetermined upper limit threshold LVs.

Since the shutter speed is low and the aperture value is large in the program diagrams (L1 to L3 here) within the area Ri, it is estimated that the shooting condition is dark, the sharpness is down and the background is out-of-focus, whereby the meaning of maintaining the image quality is rarely useful, and the number of remaining shots should be preferentially secured by decreasing the target code amount and raising the compression rate.

Also, since the shutter speed is high and the aperture value is small in the program diagrams (L1 and L2 here) within the upper limit area Rs, it is estimated that the shooting condition is bright, the sharpness is high and the background is not out-of-focus, whereby the image quality should be preferentially secured by increasing the target code amount and decreasing the compression rate.

The shape of the areas Ri and Rs of FIG. 10 exemplifies an elliptical area, but the shape is not specifically limited.

In this manner, the compression rate can be optimized in consideration of a difference in the exposure condition.

### Seventh Embodiment

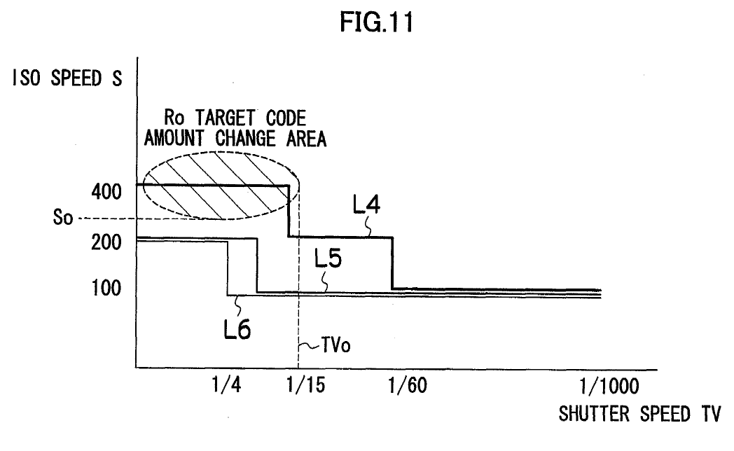

FIG. 11 shows the program diagrams L4 to L6 according to the shooting mode (or optional shooting function). Herein, the shutter speed TV is taken along the transverse axis, and the ISO speed S is taken along the longitudinal axis, whereby the relationship between the shutter speed TV and the ISO speed for each shooting mode (or optional shooting function) is stipulated.

Herein, the target code amount (N1, N2, N3, N4, etc.) may be decreased and the compression rate may be raised in a predetermined target code amount change area R0 where the shutter speed TV is less than a predetermined threshold TV0, and the ISO speed is greater than or equal to a predetermined threshold S0.

Since the program diagram L4 within the area R0 stipulates the relationship that the ISO speed is high and the shutter speed is low, it is estimated that the shooting condition is dark, and the sharpness is down, whereby the meaning of maintaining the image quality is rarely useful, and the number of remaining shots should be preferentially secured by decreasing the target code amount and raising the compression rate.

The shape of the area R0 of FIG. 11 exemplifies an elliptical area, but the shape is not specifically limited.

In this manner, the compression rate can be optimized in consideration of a difference in the ISO speed.

### Eighth Embodiment

In the table exemplified in FIG. 9 (fifth embodiment), when the number of shots, and the shooting mode and additional function are specified, the compression rate corresponding to them is specified. Namely, when the compression rate is specified from the table, it is unnecessary to set the target code amount and carry out the pre-compression.

That is, even when the setting of the target code amount at S83, S86 and S89 in the remaining shot number calculation process of the fifth embodiment is omitted, the compression rate corresponding to the set number of shots, and the shooting mode and additional function is specified from the table, the number of remaining shots decision function is corrected according to this compression rate, and the accurate number of remaining shots can be calculated by substituting the number of taken shots x1 into the corrected function.

However, since the approximate code amount by the pre-compression is unknown, it is required that the compression rates defined in the table are set to the statistically valid values to reach approximately the default target code amount for each shooting mode whatever image data is compressed.

What is claimed is:

1. A photographing apparatus which converts a subject image received via a photographic optical system into image data, compresses and encodes the image data, and stores the image data in a predetermined storage medium, comprising:
a calculation part which calculates the storable number of the image data according to an available space of the predetermined storage medium using a predetermined prediction function;
a shooting condition setting part which sets a shooting condition including changing a shooting mode or adding a shooting function;
a target code amount setting part which sets a target code amount of image data according to the shooting condition set by the shooting condition setting part;
a compression rate setting part which sets a compression rate of image data to reach the target code amount set by the target code amount setting part; and
a prediction function correcting part which corrects the prediction function to be used by the calculation part, based on the compression rate set by the compression rate setting part.

2. The photographing apparatus according to claim 1, further comprising
an image stabilizing part which corrects a camera shake of the photographing apparatus, wherein when the shooting condition setting part sets the image stabilization of the image stabilizing part to turn on, the target code amount setting part sets the target code amount to a lower value than a predetermined code amount threshold.

3. The photographing apparatus according to claim 1, wherein the prediction function comprises a table which defines the compression rate for each shooting condition according to the available space.

4. The photographing apparatus according to claim 1, further comprising
a digital zoom part which carries out a digital zoom for the image data,
wherein when the shooting condition setting part sets the digital zoom of the digital zoom part to turn on, the target code amount setting part sets the target code amount to a lower value than a predetermined code amount threshold.

5. The photographing apparatus according to claim 4, wherein the prediction function comprises a table which defines the compression rate for each shooting condition according to the available space.

6. The photographing apparatus according to claim 4, further comprising
an image stabilizing part which corrects a camera shake of the photographing apparatus, wherein when the shooting condition setting part sets the image stabilization of the image stabilizing part to turn on, the target code amount setting part sets the target code amount to a lower value than a predetermined code amount threshold.

7. The photographing apparatus according to claim 6, wherein the prediction function comprises a table which defines the compression rate for each shooting condition according to the available space.

8. The photographing apparatus according to claim 6, wherein the image stabilizing part performs digital image stabilization.

9. The photographing apparatus according to claim 8, wherein the prediction function comprises a table which defines the compression rate for each shooting condition according to the available space.

10. The photographing apparatus according to claim 1, wherein the target code amount setting part increases or decreases the target code amount above or below the predetermined code amount threshold in response to a shutter speed and an aperture value being set within a specific area in a program diagram which defines the relationship between the shutter speed and the aperture value in the photographic optical system.

11. The photographing apparatus according to claim 1, wherein the target code amount setting part increases or decreases the target code amount above or below the predetermined code amount threshold in response to a shutter speed and a photographic sensitivity being set within a specific area in a program diagram which defines the relationship between the shutter speed and the photographic sensitivity in the photographic optical system.

12. A photographing method which converts a subject image received via a photographic optical system into image data, compresses and encodes the image data, and stores the image data in a predetermined storage medium, comprising:
a step of calculating the storable number of the image data according to an available space of the predetermined storage medium using a predetermined prediction function;
a step of setting a shooting condition including changing a shooting mode or adding a shooting function;
a step of setting a target code amount of image data according to the set shooting condition;
a step of setting a compression rate of image data to reach the set target code amount; and
a step of correcting the prediction function, based on the set compression rate.

13. A program for causing a computer to perform the photographing method according to claim 12.

14. A photographing apparatus which converts a subject image received via a photographic optical system into image data, compresses and encodes the image data, and stores the image data in a predetermined storage medium, comprising:
a calculation part which calculates the storable number of the image data according to an available space of the predetermined storage medium using a predetermined prediction function;
a shooting condition setting part which sets a shooting condition including changing a shooting mode or adding a shooting function;
a storage part which stores a table which defines a compression rate for each shooting condition corresponding to the available space of the predetermined storage medium;
a compression rate setting part which sets the compression rate corresponding to the shooting condition set by the shooting condition setting part and the current available space of the predetermined storage medium by referring to the table of the storage part; and
a prediction function correcting part which corrects the prediction function to be used by the calculation part, based on the compression rate set by the compression rate setting part.

15. A photographing method which converts a subject image received via a photographic optical system into image data, compresses and encodes the image data, and stores the image data in a predetermined storage medium, comprising:
a step of calculating the storable number of the image data according to an available space of the predetermined storage medium using a predetermined prediction function;
a step of setting a shooting condition including changing a shooting mode or adding a shooting function;
a step of storing a table which defines a compression rate for each shooting condition corresponding to the available space of the predetermined storage medium;
a step of setting the compression rate corresponding to the set shooting condition and the current available space of the predetermined storage medium by referring to the table; and
a step of correcting the prediction function, based on the set compression rate.

16. A program for causing a computer to perform the photographing method according to claim 15.
